(19) United States
(12) Patent Application Publication
(10) Pub. No.: US 2010/0194369 A1
(43) Pub. Date: Aug. 5, 2010

(54) DC-DC CONVERTER AND SWITCHING CONTROL CIRCUIT

(75) Inventors: Tomiyuki NAGAI, Tokyo (JP); Yoshihiro Takahashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 12/695,342

(22) Filed: Jan. 28, 2010

(30) Foreign Application Priority Data
Feb. 5, 2009 (JP) 2009-024588

(51) Int. Cl. G05F 1/618

(52) U.S. Cl. 323/284

(57) ABSTRACT

A switching control circuit for controlling on/off of a switching element for driving an inductor for voltage conversion, the switching control circuit including: a voltage comparator for determining whether an output voltage of the inductor is in a first state where the output voltage is equal to or higher than a predetermined electric potential or in a second state where the output voltage is lower than the predetermined electric potential; a timing determination unit for determining an on-timing to turn on the switching element based on a clock signal having a predetermined frequency even when the output voltage is in the first state; and a drive control circuit for generating a driving signal to turn on or turn off the switching element based on an output signal of the timing determination unit.

### BACKGROUND OF THE INVENTION

1. Field of the Invention

The present invention relates to a DC-DC converter of a switching regulator system for converting a direct current (DC) voltage and a switching control circuit thereof, and in particular, relates to a technology effective to achieve a high-speed load response in the DC-DC converter.

2. Description of the Related Art

Currently, progress is made in development of a semiconductor integrated circuit (IC) such as a CPU for a low voltage and a large current. Accordingly, a load current often changes. Therefore as a characteristic of a DC-DC converter which supplies a DC source voltage to a system using the IC, a high-speed load response is required. As a power supply apparatus which supplies the DC source voltage to the system using the IC, a DC-DC converter of a switching regulator system is often used.

As a conventional DC-DC converter of the switching regulator system, there is a DC-DC converter which controls an output voltage using a pulse width modulation control method (PWM DC-DC converter hereinafter). As shown in FIG. 4, the PWM DC-DC converter includes a switching element M1 for driving an inductor (coil) L1 by applying a DC input voltage Vin to the coil L1 in order to flow an electric current and store energy into the coil L1; a switching element M2 for rectifying the electric current in the coil L1 while the switching element M1 is off and the energy is released; and a switching control circuit 20 to generate a driving pulse which turns on one of the switching elements M1 and M2, and turns off the other. The switching control circuit 20 includes an error amplifier 25 to output a voltage in accordance with an electric potential difference obtained by comparing a feedback voltage VFB, which is a voltage fed back from the output side of the PWM DC-DC converter, with a reference voltage Vref1; a PWM comparator 27 to compare output of the error amplifier 25 with a waveform signal of such as a triangular wave generated at a waveform generator 26, and generate a control pulse; and a drive control circuit 24 to generate the driving pulse for the switching element M1 or M2 based on the control pulse outputted from the PWM comparator 27.

The invention described in Japanese Patent Application Laid-Open Publication No. 2002-044938 is an example for a power supply apparatus of a switching regulator system which controls an output voltage with the PWM control method.

In the PWM DC-DC converter shown in FIG. 4, the error amplifier 25 is often connected with a capacitor having capacitance Cf for phase compensation in order to prevent oscillation caused by a feedback loop. In such case, the error amplifier 25 functions as a kind of integration circuit, and accordingly a response to a load change slows. Moreover, for stable operation of a control system thereof, it is necessary to set the highest frequency of the error amplifier 25 to be equal to or less than a cutoff frequency of a LC circuit, which is composed of an inductor L and a capacitor C, on the output side, and accordingly, the circuitry of the PWM DC-DC converter is not suitable to achieve the high-speed load response.

In addition, currently, a current-mode DC-DC converter, which has a better response than a voltage-mode DC-DC converter such as the PWM DC-DC converter, is provided. The current-mode DC-DC converter has a different way in phase compensation compared with the voltage-mode DC-DC converter. A frequency range of the error amplifier in the current-mode DC-DC converter can be made higher than that in the voltage-mode DC-DC converter, so that the load response can be speeded up in the current-mode DC-DC converter. However, as long as the current-mode DC-DC converter uses the error amplifier as the voltage-mode DC-DC converter does, the integration circuit exists in a loop thereof. Therefore speed-up of the load response is limited. Furthermore, the current-mode DC-DC converter has not only a voltage control loop but also a current control loop, and accordingly the circuitry of the current-mode DC-DC converter is complicated.

For the reasons, a DC-DC converter which controls an output voltage using a ripple detection control method (ripple detection DC-DC converter hereinafter) shown in FIG. 5 was examined. The ripple detection DC-DC converter compares a feedback voltage VFB with a reference voltage Vref by the comparator 21 to generate the driving pulse. The feedback voltage VFB is a voltage obtained by dividing an output voltage Vout by resistors R1 and R2. According to the examination, since the error amplifier that functions as the integration circuit is not required, the ripple detection DC-DC converter shown in FIG. 5 has an excellent response toward a load change, and a circuitry thereof is simple. On the other hand, the switching frequency thereof changes in accordance with a change of a load current because the switching frequency is determined based on a delay of a circuit of the ripple detection DC-DC converter. Consequently, a voice noise is produced when the switching frequency goes down to and reaches a voice band, and a common mode noise is produced when the switching frequency goes up to and reaches a high frequency range, so that bad influence is exerted on another circuit on the same substrate, which is a problem.

### SUMMARY OF THE INVENTION

The present invention is made to solve the problem. An object of the present invention is to achieve a high-speed load response and to reduce a noise in a voice band and a high frequency range in a DC-DC converter of a switching regulator system.

Another object of the present invention is to provide a DC-DC converter and a switching control circuit thereof which can achieve the high-speed load response and reduce the noise in the voice band and the high frequency range.

To achieve the objects, according to a first aspect of the present invention, a switching control circuit for controlling on/off of a switching element for driving an inductor for voltage conversion, the switching control circuit includes: a voltage comparator for determining whether an output voltage of the inductor is in a first state where the output voltage is equal to or higher than a predetermined electric potential or in a second state where the output voltage is lower than the predetermined electric potential; a timing determination unit for determining an on-timing to turn on the switching element based on a clock signal having a predetermined frequency; and a drive control circuit for generating a driving signal to turn on or turn off the switching element based on an output signal of the timing determination unit, wherein the switching element is turned off and an electric current is not supplied to the inductor when the output voltage is in the first state, wherein the switching element is turned on and an electric current is supplied to the inductor when the output voltage is in the second state, and wherein the timing determination unit determines the on-timing based on the clock signal even when the output voltage is in the first state.

According to a second aspect of the present invention, a DC-DC converter includes: an inductor for voltage conversion; a first switching element for driving the inductor by flowing an electric current into the inductor; a second switching element for rectifying the electric current flown into the inductor while the first switching element is off; a smoothing condenser connected to an output terminal of the DC-DC converter; and a switching control circuit for generating a driving signal to drive the first switching element.

### BRIEF DESCRIPTION OF THE DRAWINGS

The present invention will be understood fully from the detailed description given hereinbelow and the accompanying drawings, which are given by way of illustration only, and thus are not intended as a definition of the limits of the present invention, and wherein;

FIG. 1 is a block diagram showing a circuitry of a DC-DC converter of a switching regulator system with synchronous rectification in accordance with an embodiment of the present invention;

FIGS. 2A-2E are timing charts showing changes of signals and electric potentials in the DC-DC converter of the switching regulator system with synchronous rectification in accordance with the embodiment of the present invention;

FIG. 3 is a block diagram showing a circuitry of a DC-DC converter in accordance with a modification of the DC-DC converter of the switching regulator system with synchronous rectification of FIG. 1;

FIG. 4 is a block diagram showing a circuitry of a conventional DC-DC converter of the switching regulator system with synchronous rectification; and

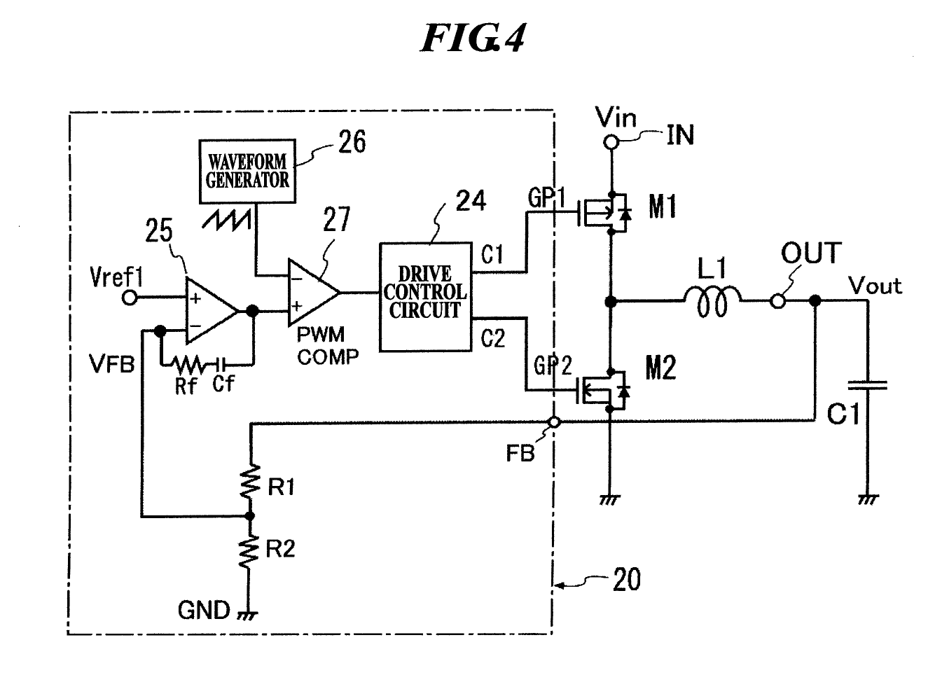

FIG. 5 is a block diagram showing a circuitry of a DC-DC converter using a ripple detection control method, the DC-DC converter which was examined prior to the present invention.

### DETAILED DESCRIPTION OF THE PREFERRED EMBODIMENT

Hereinafter, an embodiment according to the present invention will be described in details referring to the drawings.

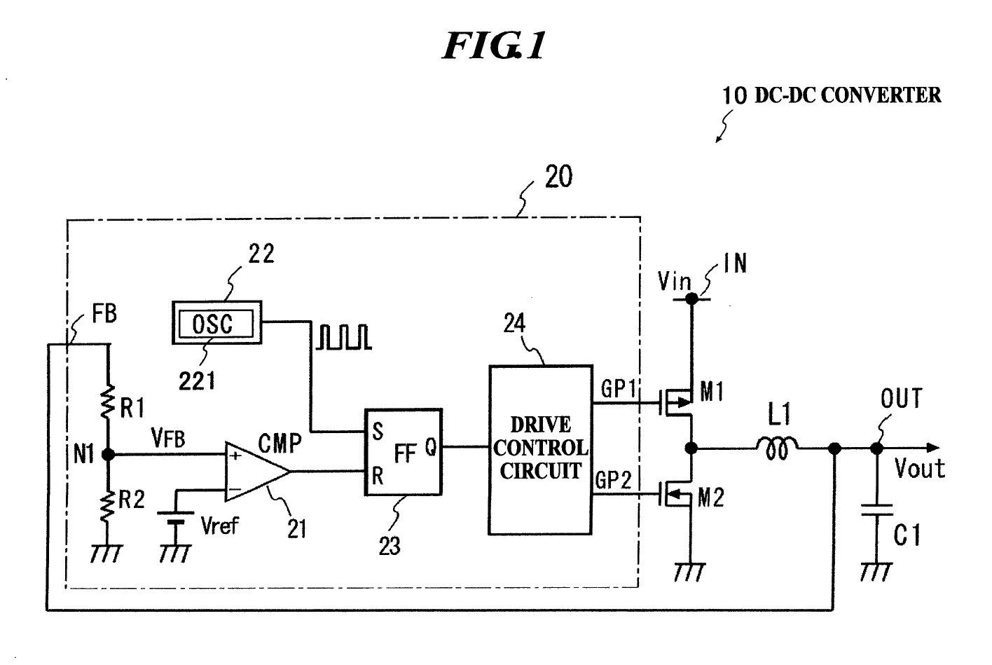

FIG. 1 shows an embodiment of a DC-DC converter of a switching regulator system with synchronous rectification in accordance with an embodiment of the present invention.

The DC-DC converter of the embodiment includes a coil L1 as an inductor; a switching transistor M1 for driving composed of a P channel MOSFET (metal-oxide-semiconductor field-effect transistor/insulated-gate field-effect transistor) and connected between a voltage input terminal IN, to which a DC input voltage Vin is applied, and one terminal of the coil L1, so as to flow a driving current into the coil L1; and a switching transistor M2 for rectification composed of an N channel MOSFET and connected between the one terminal of the coil L1 and a ground.

The DC-DC converter of the embodiment also includes a switching control circuit 20 to turn on and off the switching transistors M1 and M2; and a smoothing condenser C1 connected between the other terminal (output terminal OUT) of the coil L1 and the ground.

This is not limitation, but among the components of the DC-DC converter, the switching control circuit 20 is formed on a semiconductor chip as a semiconductor IC (power supply control IC), and the coil L1, the condenser C1, and the switching transistors M1 and M2 are connected to terminals for external connection provided with the IC as external components in the embodiment.

In the DC-DC converter of the embodiment, driving pulses GP1 and GP2, which turn on one of the switching transistors M1 and M2 and turn off the other in a complementary style, are generated by the switching control circuit 20. In a steady state, when the switching transistor M1 is turned on, the DC input voltage Vin is applied to the coil L1, and an electric current toward the output terminal OUT flows, so that the smoothing condenser C1 is charged. When the switching transistor M1 is turned off, the switching transistor M2 is turned on instead, and the electric current flows into the coil L1 through the switching transistor M2.

The switching control circuit 20 includes resistors R1 and R2, a comparator 21 as a voltage comparator, a clock generator 22, a RS flip-flop 23, and a drive control circuit 24. The resistors R1 and R2 are connected in series between a feedback terminal FB, where an output voltage Vout is fed back from the output terminal OUT, and the ground, and divide the output voltage Vout by a resistance ratio thereof. The comparator 21 is where a feedback voltage VFB, which is the divided voltage by the resistance ratio of the resistors R1 and R2, and a reference voltage Vref are inputted. The clock generator circuit 22 has a built-in oscillator 221, and generates a clock pulse CLK which has a predetermined frequency and relatively narrow pulse width. The RS flip-flop 23 is where the clock pulse CLK (clock CLK hereinafter) generated at the clock generator 22 and output of the comparator 21 are inputted into a set terminal S and a reset terminal R thereof, respectively. The drive control circuit 24 receives output of the flip-flop 23, and generates and outputs gate driving signals GP1 and GP2 of the switching transistors M1 and M2.

It is preferable that the drive control circuit 24 be configured to generate and output the gate driving signals GP1 and GP2 which have a dead time in order to prevent the switching transistors M1 and M2 from being on together and a through-current from flowing thereby. Furthermore, it is preferable to use a comparator having a hysteresis property as the comparator 21 of the embodiment, so that the output of the comparator 21 can be prevented from changing in error when a noise is entered into the feedback voltage VFB.

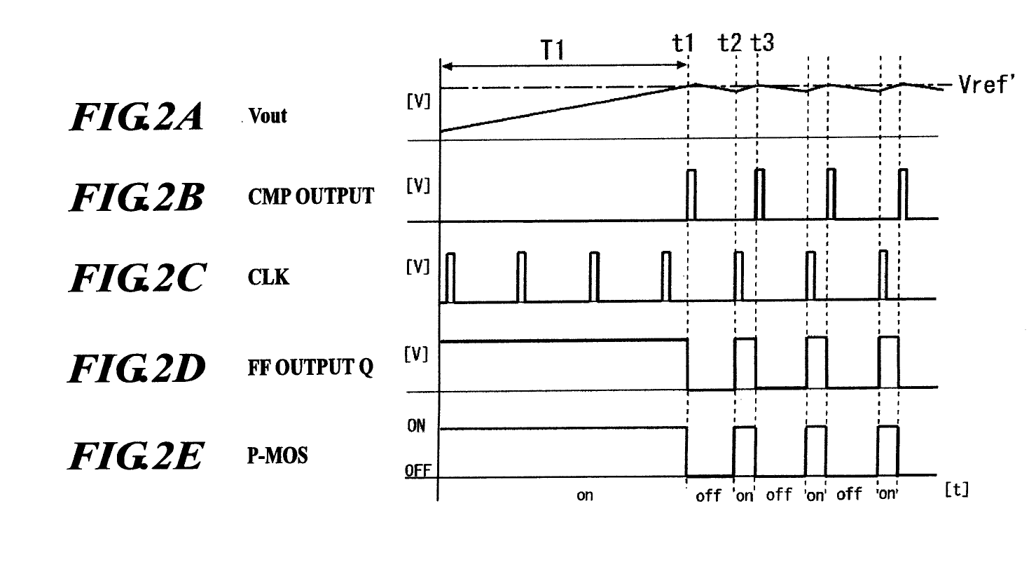

Next, operation of the switching control circuit 20 will be described referring to the timing charts of FIGS. 2A-2E. The Vref′ shown in FIG. 2A represents an electric potential of the output voltage Vout in a case where an electric potential of a connection node N1 of the resistors R1 and R2 agrees with the reference voltage Vref.

In the DC-DC converter of FIG. 1, while the output voltage Vout is lower than the Vref′ which corresponds to the reference voltage Vref, namely, during T1 in FIGS. 2A-2E, the output of the comparator 21 is at a low level (insignificant signal) as shown in FIG. 2B. During the period, output Q of the flip-flop 23 is at a high level, and the drive control circuit 24 outputs the gate driving signals GP1 and GP2 which turn on the switching transistor M1 and turn off the switching transistor M2, respectively.

As a result, as shown in FIG. 2A, the output voltage Vout gradually increases, and the node N1 increases accordingly during T1 in FIGS. 2A-2E. When the output voltage Vout becomes equal to or higher than the Vref′, the output of the comparator 21 changes from the low level to a high level (sufficient signal) thereof to reset the flip-flop 23, and the output Q of the flip-flop 23 changes to a low level thereof at a timing t1 in FIGS. 2A-2E. Then, the drive control circuit 24 outputs the gate driving signals GP1 and GP2 which turn off the switching transistor M1 and turn on the switching transistor M2, respectively. Thereby, the output voltage Vout starts to decline, the output of the comparator 21 changes to the low level, and the output Q of the flip-flop 23 stays at the low level.

The clock CLK is periodically inputted into the set terminal S of the flip-flop 23. When the clock CLK is inputted into the set terminal S thereof (timing t2 in FIGS. 2A-2E), the flip-flop 23 is set, and the output Q changes to the high level. Then, again, the drive control circuit 24 outputs the gate driving signals GP1 and GP2 which turn on the switching transistor M1 and turn off the switching transistor M2, respectively. Thereby, the amount of the electric current flown into the coil L1 becomes more than that of the electric current flown into a load (not shown), and hence the output voltage Vout increases again.

When the output voltage Vout becomes equal to or higher than the Vref′, the output of the comparator 21 changes from the low level to the high level to reset the flip-flop 23, and the output Q changes to the low level to turnoff the switching transistor M1 at a timing t3 in FIGS. 2A-2E. The output voltage Vout maintains an almost constant voltage by repeating the operation. As described above, in the DC-DC converter of the embodiment, the clock CLK and the output of the comparator 21, respectively, determine an on-timing and an off-timing of the switching transistor M1.

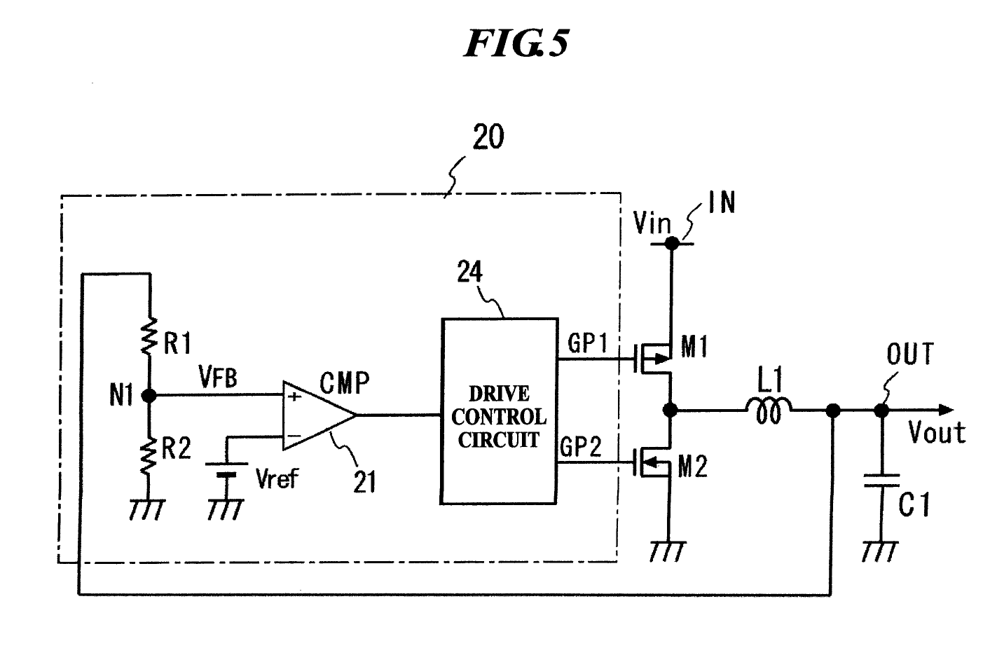

In the ripple detection DC-DC converter which does not have the clock generator 22 and the flip-flop 23 as shown in FIG. 5, there is a problem that a noise may be produced in the voice band and the high frequency range since the switching frequency changes between several kHz and several MHz in accordance with a load. On the other hand, in the DC-DC converter of the embodiment, there is no problem that a noise may be produced in the voice band and the high frequency range since the switching frequency is a fixed value determined based on the frequency of the clock CLK which is generated by the clock generator 22.

Further, since a change of the output voltage to a load at a large current is less in the DC-DC converter of the embodiment than in the DC-DC converter of FIG. 5, a voltage needed to drive the DC-DC converter of the embodiment can be lowered, and accordingly power consumption thereof can be reduced. Also, since the DC-DC converter of the embodiment can be operated in a relatively high frequency range owing to the fixed value of the switching frequency, smaller values of the coil and the condenser can be set. As a result, a footprint of the DC-DC converter of the embodiment can be reduced, and accordingly the present invention can contribute to making a smaller and thinner DC-DC converter. Still further, the values of the coil and the condenser can be easily determined since the switching frequency does not greatly change, and also designing the circuit of the DC-DC converter of the embodiment and a substrate therefor can be easy since the circuitry thereof does not easily cause anomalous oscillation.

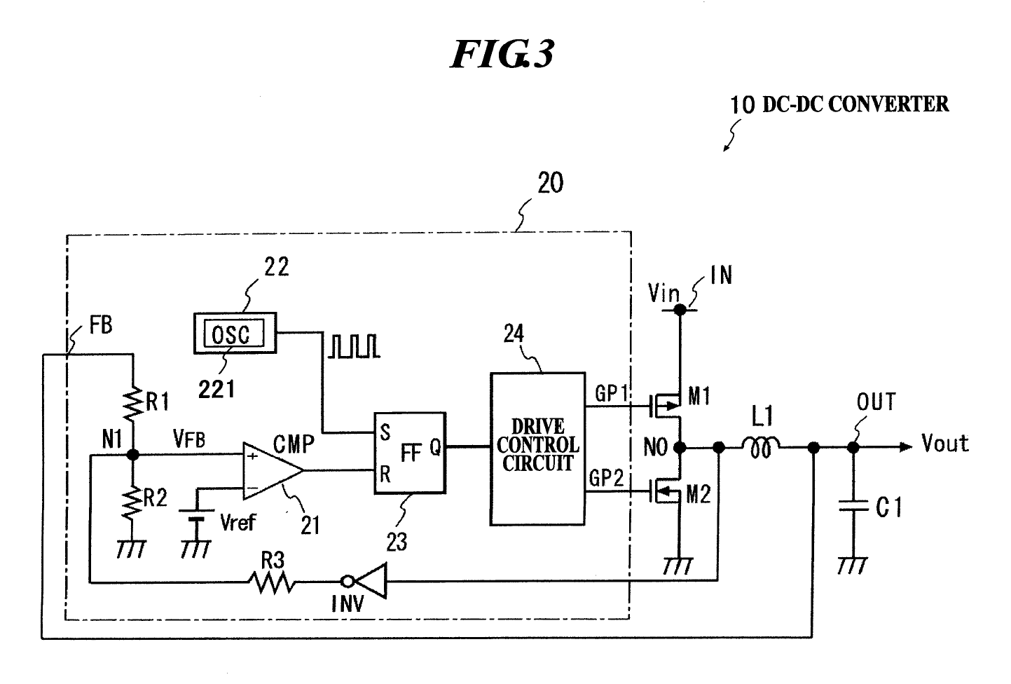

Next, a modification of the DC-DC converter of the embodiment according to the present invention will be described referring to FIG. 3. In the modification shown in FIG. 3, an inverter INV and a resistor R3 are connected in series between a connection node NO of the switching transistors M1 and M2, the connection node NO which is connected to the coil L1, and the connection node N1 of the resistors R1 and R2 which divide the output voltage Vout. An input of the comparator 21 changes according to an electric potential of the connection node NO in the modification. Other than those, the configuration of the DC-DC converter of FIG. 3 is the same as that of FIG. 1.

In the DC-DC converter of the modification, when the switching transistor M1 is on and the electric potential of the node NO is high, the electric potential of the node N1, i.e. the input of the comparator 21, is decreased by output of the inverter INV being at a ground electric potential level and passing through the resistor R3. Consequently, an apparent output voltage decreases, and accordingly the same result as obtained when the reference voltage Vref increases can be obtained. On the other hand, when the switching transistor M1 is off and the electric potential of the node NO is low, the electric potential of the node N1, i.e. the input of the comparator 21, is increased by the output of the inverter INV being at a power source voltage level and passing through the resistor R3.

Consequently, the apparent output voltage increases, and accordingly the same result as obtained when the reference voltage Vref decreases can be obtained. By the operation mentioned above, the comparator 21 can obtain the hysteresis with which a determination value changes in accordance with the change of the output voltage Vout, i.e. the ripple. As a result, the change of the output voltage Vout can be prevented from entering into the power source voltage as a noise, and malfunction of the comparator 21, which is caused by a noise entering into an input terminal of the comparator 21 via a parasitic capacitance existing in a substrate or between interconnects, can be prevented. It is preferable that a value of the resistor R3 and a constant of a transistor which is composed of the inverter INV be determined such that the size of the hysteresis added by the inverter INV and the resistor R3 is smaller than the range of the node N1, within which the node 1 changes according to the ripple of the output voltage Vout.

Hereinabove, the present invention is concretely described referring to, but not limited to, the embodiment and the modification. In the embodiment and the modification, the RS flip-flop having the set terminal S and the reset terminal R is used as the flip-flop 23, for example. Instead, another type of flip-flop or the RS flip-flop which is configured such that the output of the comparator 21 and the clock CLK are inputted into the set terminal S and the reset terminal R thereof, respectively, by changing the logic of the drive control circuit 24 may be used.

A case where the present invention is applied to the DC-DC converter with synchronous rectification is described referring to the embodiment and the modification. However, the present invention can also be applied to a DC-DC converter with diode rectification in which a diode is used instead of the switching transistor M2 shown in FIGS. 1 and 3.

In the embodiment and the modification, the external components which are formed separately from the power supply control IC are used as the switching transistors M1 and M2. Instead, on-chip components which are formed on the same semiconductor chip as the power supply control IC may be used. Also, in the embodiment and the modification, the resistors R1 and R2 which divide the output voltage Vout applied to the feedback terminal FB are formed on the chip. Instead, the resistors R1 and R2 may be the external components, and the output voltage Vout which is divided outside the chip may be applied to the feedback terminal FB.

Moreover, in the embodiment and the modification, the clock pulse inputted into the set terminal S of the flip-flop 23 is generated by the clock generator 22 which is built in the chip of the switching control circuit 20. Instead, the clock pulse or an oscillation signal from which the clock pulse is generated may be obtained from outside the chip.

Hereinabove, cases where the present invention is applied to a step-down DC-DC converter are described referring to the embodiment and the modification. However, the present invention is not limited to the cases. The present invention can also be applied to a step-up DC-DC converter or an inverting DC-DC converter which produces a negative voltage, for example.

According to the embodiment and the modification of the present invention, the switching transistor M1 is controlled such that the output voltage is constant while the comparator 21 detects a ripple of the output voltage, so that the high-speed load response can be achieved. Also, the switching transistor M1 is controlled based on the frequency of the clock signal, so that a change of the switching frequency according to a load change is avoidable, and the noise in the voice band and the high frequency range can be reduced.

Preferably, the timing determination unit determines the off-timing of the switching transistor M1 based on the output of the comparator 21, and determines the on-timing of the switching transistor M1 based on the clock signal. A control loop in which the switching frequency is determined based on the frequency of the clock signal can be easily built thereby.

Preferably, the timing determination unit is composed of the flip-flop 23 having the set terminal S and the reset terminal R, and the output of the comparator 21 is inputted into the reset terminal R and the clock signal is inputted into the set terminal S, or the output of the comparator 21 is inputted into the set terminal S and the clock signal is inputted into the reset terminal R. The switching control circuit 20 which can determine the on-timing and the off-timing of the switching transistor M1 can be simple circuitry, and accordingly can be easily made.

Preferably, the clock signal is a pulse signal; and the flip-flop 23 is in a reset state to turn off the switching transistor M1 while the significant signal is inputted into the reset terminal R from the comparator 21, and is turned to be in a set state when the clock signal is inputted into the reset terminal R to turn on the switching transistor M1 while the insignificant signal is inputted into the reset terminal R from the comparator 21. The switching transistor M1 is continuously turned on thereby when a load is small, and as a result, a decrease in the switching frequency is avoidable.

Preferably, the switching control circuit 20 further includes: the oscillator 221 for generating an oscillation signal having a predetermined frequency; and the clock generator 22 for generating a pulse signal by shaping a waveform of the oscillation signal generated by the oscillator 221, and outputting the pulse signal as the clock signal. In a case where the switching control circuit 20 is configured as a semiconductor IC, it is not required thereby to provide an oscillator and a clock generator which are made separately from the switching control circuit 20, so that miniaturization of a system using the semiconductor IC is available.

According to the embodiment and the modification of the present invention, the high-speed load response and the reduction of the noise in the voice band and the high frequency range can be achieved in the DC-DC convertor 10 of the switching regulator system.

The entire disclosure of Japanese Patent Application No. 2009-024588 filed on Feb. 5, 2009 including description, claims, drawings, and abstract are incorporated herein by reference in its entirety.

1. A switching control circuit for controlling on/off of a switching element for driving an inductor for voltage conversion, the switching control circuit comprising:
a voltage comparator for determining whether an output voltage of the inductor is in a first state where the output voltage is equal to or higher than a predetermined electric potential or in a second state where the output voltage is lower than the predetermined electric potential;
a timing determination unit for determining an on-timing to turn on the switching element based on a clock signal having a predetermined frequency; and
a drive control circuit for generating a driving signal to turn on or turn off the switching element based on an output signal of the timing determination unit,
wherein the switching element is turned off and an electric current is not supplied to the inductor when the output voltage is in the first state,
wherein the switching element is turned on and an electric current is supplied to the inductor when the output voltage is in the second state, and
wherein the timing determination unit determines the on-timing based on the clock signal even when the output voltage is in the first state.

2. The switching control circuit according to claim 1,
wherein the timing determination unit determines an off-timing of the switching element based on output of the voltage comparator, and determines the on-timing of the switching element based on the clock signal.

3. The switching control circuit according to claim 2,
wherein the timing determination unit is composed of a flip-flop circuit, having a set terminal and a reset terminal, and
wherein the output of the voltage comparator is inputted into the reset terminal and the clock signal is inputted into the set terminal, or the output of the voltage comparator is inputted into the set terminal and the clock signal is inputted into the reset terminal.

4. The switching control circuit according to claim 3, wherein
the clock signal is a pulse signal; and
the flip-flop circuit is in a reset state to turn off the switching element while a significant signal inputted into the reset terminal from the voltage comparator, and is turned to be in a set state when the clock signal is inputted into the reset terminal to turn on the switching element while an insignificant signal is inputted into the reset terminal from the voltage comparator.

5. The switching control circuit according to claim 1, further comprising:
an oscillator for generating an oscillation signal having a predetermined frequency; and
a clock generator for generating a pulse signal by shaping a waveform of the oscillation signal generated by the oscillator, and for outputting the pulse signal as the clock signal.

6. The switching control circuit according to claim 2, further comprising:
an oscillator for generating an oscillation signal having a predetermined frequency; and
a clock generator for generating a pulse signal by shaping a waveform of the oscillation signal generated by the oscillator, and for outputting the pulse signal as the clock signal.

7. The switching control circuit according to claim 3, further comprising:
an oscillator for generating an oscillation signal having a predetermined frequency; and
a clock generator for generating a pulse signal by shaping a waveform of the oscillation signal generated by the oscillator, and for outputting the pulse signal as the clock signal.

8. The switching control circuit according to claim 4, further comprising:
an oscillator for generating an oscillation signal having a predetermined frequency; and
a clock generator for generating the pulse signal by shaping a waveform, of the oscillation signal generated by the oscillator, and for outputting the pulse signal as the clock signal.

9. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 1 for generating a driving signal to drive the first switching element.

10. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 2 for generating a driving signal to drive the first switching element.

11. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 3 for generating a driving signal to drive the first switching element.

12. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 4 for generating a driving signal to drive the first switching element.

13. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 5 for generating a driving signal to drive the first switching element.

14. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 6 for generating a driving signal to drive the first switching element.

15. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 7 for generating a driving signal to drive the first switching element.

16. A DC-DC converter comprising:
an inductor for voltage conversion;
a first switching element for driving the inductor by flowing an electric current into the inductor;
a second switching element for rectifying the electric current flown into the inductor while the first switching element is off;
a smoothing condenser connected to an output terminal of the DC-DC converter; and
the switching control circuit according to claim 8 for generating a driving signal to drive the first switching element.
